(19) United States
(12) Patent Application Publication
(10) Pub. No.: US 2012/0013602 A1
(43) Pub. Date: Jan. 19, 2012

(54) STEREOSCOPIC IMAGE DISPLAY

(75) Inventors: Seung-Hoon LEE, Hwaseong-si (KR); Hae-Young YUN, Suwon-si (KR); Kyung-Ho JUNG, Yongin-si (KR); Hee-Seop KIM, Hwaseong-si (KR); Hwi KIM, Seoul (KR)

(73) Assignee: SAMSUNG ELECTRONICS CO., LTD., Suwon-si, (KR)

(21) Appl. No.: 12/966,422

(22) Filed: Dec. 13, 2010

(30) Foreign Application Priority Data
Jul. 14, 2010 (KR) 10-2010-0068129

(51) Int. Cl. G06T 15/00

(52) U.S. Cl. 345/419

(57) ABSTRACT

A stereoscopic image display includes; a display panel including a pixel including; a first subpixel, and a second subpixel disposed adjacent to the first subpixel, wherein the first subpixel and the second subpixel are adjacent along a subpixel border line which is a virtual line disposed at an interface between the first subpixel and the second subpixel, and a lenticular lens disposed on the display panel, the lenticular lens having a lens axis, in which the lens axis and a subpixel border line may intersect each other, or a portion of the subpixel border line may be substantially parallel with the lens axis.

This application claims priority to Korean Patent Application No. 10-2010-0068129, filed on Jul. 14, 2010, and all the benefits accruing therefrom under 35 U.S.C. §119, the content of which in its entirety is herein incorporated by reference.

### BACKGROUND OF THE INVENTION

(a) Field of the Invention

A stereoscopic image display is provided.

(b) Description of the Related Art

In general, a three-dimensional (“3D”) image display technology represents a stereoscopic arrangement of objects using binocular parallax in order to allow a user to perceive a depth component in an image. Binocular parallax is one of the most important factors for producing a stereoscopic effect at a short distance. That is, different 2D images are transmitted to the left eye and the right eye of the user, and when the image transmitted to the left eye (hereafter, referred to as “left eye image”) and the image transmitted to the right eye (hereafter, referred to as “right eye image”) are transmitted to the brain of the user, the left eye image and the right eye image are converged in the brain of the user into a stereoscopic image having depth information.

A stereoscopic image display device uses binocular parallax and the different types of stereoscopic image display devices may be classified into a stereoscopic type using glasses, such as shutter glasses and polarized glasses, and an autostereoscopic type which does not use glasses, wherein the autostereoscopic type display instead uses a different device such as a lenticular lens and/or a parallax barrier.

In the lenticular lens type of stereoscopic image display device, the lenticular lens is disposed above the display, and an image outputted from the display is refracted to the left eye and the right eye through the lenticular lens, and then the left eye image and the right eye image are transmitted to the left eye and the right eye, respectively, thereby displaying a stereoscopic image.

Using the lenticular lens may cause a dark region of a pixel transmitted to the left eye or the right eye in accordance with the relative position of the lenticular lens and the observer's eyes, in which a striped moire pattern may be shown and the display quality may be deteriorated.

### BRIEF SUMMARY OF THE INVENTION

An exemplary embodiment of the present invention provides a stereoscopic image display which includes; a display panel including a pixel including; a first subpixel, and a second subpixel disposed adjacent to the first subpixel, wherein the first subpixel and the second subpixel are adjacent along a subpixel border line which is a virtual line disposed at an interface between the first subpixel and the second subpixel, and a lenticular lens disposed on the display panel, the lenticular lens having a lens axis, wherein the lens axis is a line where a curved surface of the lenticular lens and a bottom surface of the lenticular lens meet, and the lens axis and the subpixel border line intersect each other.

In one exemplary embodiment, a left region of the first subpixel and a right region of the first subpixel may be divided by the lens axis, and an area of the left region of the first subpixel may be substantially the same as an area of the right region of the first subpixel. A left region of the second subpixel and a right region of the second subpixel may be divided by the lens axis, and an area of the left region of the second subpixel may be substantially the same as an area of the right region of the second subpixel.

In one exemplary embodiment, two corners of the pixel may face each other, and the lens axis may connect the two corners of the pixel. An absolute value of a slope of the lens axis may be about 3 to about 6.

In one exemplary embodiment, an area ratio of the first subpixel and the second subpixel may be about 1:0.5 to about 1:3.

In one exemplary embodiment, the subpixel border line may be a curved line. The subpixel border line may be a straight line. The subpixel border line may have a stepped shape.

In one exemplary embodiment, the display panel may include a first black matrix disposed at an upper end portion of the pixel and a second black matrix disposed at a lower end portion of the pixel.

In one exemplary embodiment, the first subpixel may include a first switching element, the first switching element may overlap the first black matrix, the second subpixel may include a second switching element, and the second switching element may overlap the second black matrix.

In one exemplary embodiment, the first subpixel may include a first storage capacitor, the first storage capacitor may overlap the first black matrix, the second subpixel includes a second storage capacitor, and the second storage capacitor may overlap the second black matrix.

In one exemplary embodiment, the display panel may include a first gate line, a second gate line, and a data line, the first switching element may be connected to the first gate line and the data line, and the second switching element may be connected to the second gate line and the data line.

In one exemplary embodiment, the first subpixel may include a first horizontal branch electrode and a first vertical branch electrode, and the second subpixel may include a second horizontal branch electrode and a second vertical branch electrode.

In one exemplary embodiment, the first subpixel may include a first upper-right branch electrode, a first upper-left branch electrode, a first lower-left branch electrode, and a first lower-right electrode, and the second subpixel may include a second upper-right branch electrode, a second upper-left branch electrode, a second lower-left branch electrode, and a second lower-right electrode.

In one exemplary embodiment, a width of the lenticular lens may be substantially the same as a product of a width of the pixel and a view number.

In one exemplary embodiment, the curved surface of the lenticular lens may include both a cylindrical surface and a facet. The number of facets may be the same as the view number of the stereoscopic image display.

Another exemplary embodiment of the present invention provides a stereoscopic image display which includes: a display panel including a pixel including; a first subpixel, and a second subpixel disposed adjacent to the first subpixel, wherein the first subpixel and the second subpixel are adjacent along a subpixel border line which is a virtual line disposed at an interface between the first subpixel and the second subpixel, and a lenticular lens disposed on the display panel, the lenticular lens having a lens axis wherein the lens axis is a line where a curved surface of the lenticular lens and a bottom surface of the lenticular lens meet, and a portion of the subpixel border line is substantially parallel with the lens axis.

In one exemplary embodiment, the second subpixel may have an hourglass shape. A length ratio of an upper part and a lower part of the hourglass may be about 2:1.

In one exemplary embodiment, the display panel may include a black matrix disposed on one of an upper end portion of the pixel and a lower end portion of the pixel.

In one exemplary embodiment, the first subpixel may include a first switching element, the second subpixel may include a second switching element, and the black matrix may overlap the first switching element and the second switching element.

In one exemplary embodiment, the display panel may include a gate line and a data line, the first switching element may be connected to the gate line and the data line, and the second switching element may be connected to the gate line and the data line.

In one exemplary embodiment, the first subpixel may include a third switching element connected to the first switching element and a down capacitor connected to the third switching element, and opposing terminals of the down capacitor may be connected to a control electrode of the third switching element and an output electrode of the third switching element, respectively.

In one exemplary embodiment, the display panel may include a gate line, a first data line, and a second data line, the first switching element may be connected to the gate line and the first data line, and the second switching element may be connected to the gate line and the second data line.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is cross-sectional view schematically showing an exemplary embodiment of a stereoscopic image display according to the present invention;

FIG. 2 is a top plan view schematically showing an exemplary embodiment of the stereoscopic image display according to the present invention;

FIG. 3 is an enlarged schematic view of one pixel PX of the exemplary embodiment of a stereoscopic image display of FIG. 2;

FIG. 4 is an enlarged schematic view of a pixel PX of another exemplary embodiment of a stereoscopic image display according to the present invention;

FIG. 5 is an enlarged schematic view of a pixel PX of another exemplary embodiment of a stereoscopic image display according to the present invention;

FIG. 6 is an equivalent circuit diagram of one pixel PX of the exemplary embodiment of a stereoscopic image display of FIG. 2;

FIG. 7 is a top plan view schematically showing another exemplary embodiment of a stereoscopic image display according to the present invention;

FIG. 8 is an enlarged schematic view of one pixel PX of the exemplary embodiment of a stereoscopic image display of FIG. 7;

FIG. 9 is an equivalent circuit diagram of one pixel PX of the exemplary embodiment of a stereoscopic image display of FIG. 7;

FIG. 10A to FIG. 10C are a luminance distribution image and luminance distribution graphs when a full white pattern is output from the exemplary embodiment of a stereoscopic image display of FIG. 2;

FIG. 11A to FIG. 11C are a luminance distribution image and luminance distribution graphs when a low-gray pattern is output from the exemplary embodiment of a stereoscopic image display of FIG. 3;

FIG. 12A to FIG. 12C are a luminance distribution image and luminance distribution graphs when a low-gray pattern is output from the exemplary embodiment of a stereoscopic image display of FIG. 4;

FIG. 13A to FIG. 13C are a luminance distribution image and luminance distribution graphs when a low-gray pattern is output from the exemplary embodiment of a stereoscopic image display of FIG. 5; and

FIG. 14A to FIG. 14C are a luminance distribution image and luminance distribution graphs when a low-gray pattern is output from the exemplary embodiment of a stereoscopic image display of FIG. 7.

### DETAILED DESCRIPTION OF THE EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element's as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

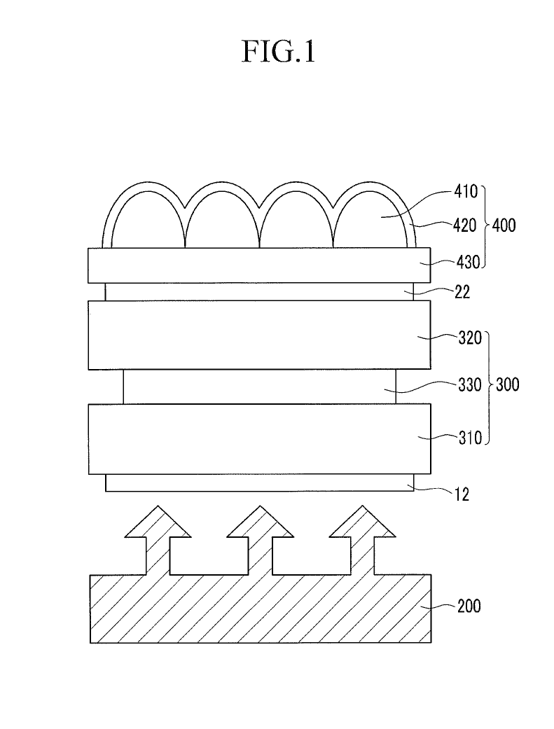

Hereinafter, an exemplary embodiment of a stereoscopic image display according to the present invention will be described in detail with reference to FIG. 1 to FIG. 9.

FIG. 1 is cross-sectional view schematically showing an exemplary embodiment of a stereoscopic image display according to the present invention. The stereoscopic image display includes a display panel 300 and a lenticular unit 400. An image output from the display panel 300 is refracted in different directions, e.g., in the left eye direction and in right eye direction, while passing through a lenticular lens 410, and the left eye image and the right eye image are transmitted to the left eye and the right eye, respectively, thereby permitting a user to perceiving a stereoscopic image.

Referring to FIG. 1, in the present exemplary embodiment the display panel 300 is a liquid crystal panel and a backlight unit 200 is disposed behind the display panel. However, various other display panels, such as an organic light emitting panel, a plasma display panel, an electrophoretic display panel, and various other types of display panel may be used. The backlight unit may be removed in the organic light emitting panel, the plasma display panel or the electrophoretic display panel.

A lower polarizer 12 may be disposed on the bottom of the display panel 300. A lower panel 310 including a thin film transistor (“TFT”) may be disposed on the lower polarizer 12. An upper panel 320 is opposite to the lower panel 310 and a liquid crystal layer 330 is disposed between the upper panel 320 and the lower panel 310. An upper polarizer 22 may be disposed at the outside of the upper panel 320.

The display panel 300 changes an alignment direction of the liquid crystal, using an electric field generated between two electrodes and displays an image by adjusting the amount of light transmitted through the display panel 300 in accordance with the alignment direction of the liquid crystal molecules.

At least one gate line, at least one data line, at least one pixel electrode, and at least one TFT are disposed on the lower panel 310. The TFT controls a voltage that is applied to the pixel electrode based on signals transmitted to the gate line and the data line. In one exemplary embodiment, the pixel electrode may be a transflective pixel electrode including a transmissive region and a reflective region. Further, a storage capacitor may be additionally formed to maintain the voltage applied to a pixel electrode for a predetermined period of time, although alternative exemplary embodiments include configurations wherein the storage capacitor is omitted.

A black matrix, a color filter and a common electrode may be disposed on the upper panel 320. In addition, alternative exemplary embodiments include configurations wherein at least one of the black matrix, the color filter and the common electrode may be disposed on the lower panel 310, instead of the upper panel 320.

When both of the common electrode and pixel electrode are disposed on the lower panel 310, at least one of the common electrode and pixel electrode may be implemented in a linear electrode type arrangement.

The liquid crystal layer 330 may include a twisted nematic (“TN”) mode liquid crystal, a vertically aligned (“VA”) mode liquid crystal, or an electrically controlled birefringence (“ECB”) mode liquid crystal.

A compensation film may be additionally disposed between the display panels 310 and 330 and the polarizers 12 and 22.

The backlight unit 200 includes light sources and exemplary embodiments of the light sources may be fluorescent lamps, such as a cold cathode fluorescent lamp (“CCFL”), and a light emitting diode (“LED”). Further, the backlight unit 200 may further include a reflector, a light guide, and a luminance improving film among various other light modification devices.

The lenticular unit 400 is disposed above the display panel 300. The lenticular unit 400 may be attached on the display panel 300 by a material such as an adhesive or various other fixing means. The lenticular unit 400 includes a lenticular lens 410. The lenticular unit 400 may further include a protection film 420 that protects the lenticular lens from abrasion or other damage and a protection substrate 430 that similarly protects the display panel 300.

In one exemplary embodiment, the lenticular lens 410 may include a refractive index-isotropic material. Exemplary embodiments of a shape of the cross section of the lenticular lens 410 include a circle, an ellipse or other similar shapes. Furthermore, in one exemplary embodiment the lenticular lens 410 may be a hybrid lens, wherein the curved surface includes both a facet (a flat surface) and a cylindrical surface. In such an exemplary embodiment, each facet may be disposed between the cylindrical surfaces. For example, the number of facets may be the same as the view number of the stereoscopic image display, and may be 2, 8, 9, and 12. The view number depends on how many pixels the lenticular lens is disposed on, and for example, the view number is 9 when the lenticular lens is disposed on nine pixels, i.e., in one exemplary embodiment, the view number is equal to the total number of pixels the lenticular lens is disposed on.

When the display panel 300 includes a plurality of pixels PX disposed in a matrix, the lenticular lens 410 may be oriented at a predetermined angle with respect to the column direction of the pixels PX. In other words, assuming that the line where the bottom surface and the curved surface of the lenticular lens 410 meet is a lens axis L, the lens axis L may be inclined at a predetermined angle. The bottom surface of the lenticular lens 410 may be approximately a parallelogram, and the upper side portion and the lower side portion of the parallelogram may be substantially disposed at the interface of the pixels, and the slope of the left and right sides of the parallelogram is the slope of the lens axis L. In one exemplary embodiment, the lens axis L may be approximately parallel with a line which connects the upper left corner of the pixel PX with the lower right corner of the pixel PX. In an alternative exemplary embodiment, the lens axis L may be approximately parallel with a line connecting the upper right corner of the pixel PX with the lower left corner of the pixel PX. For example, the absolute value of the slope of the lens axis L may be about 3 to about 6. In this configuration, the upper side or the lower side of the pixel PX, e.g., a side typically parallel with a gate line, functions as the x-axis and the left side or the right side of the pixel PX, e.g., a side typically parallel with a data line, functions as the y-axis.

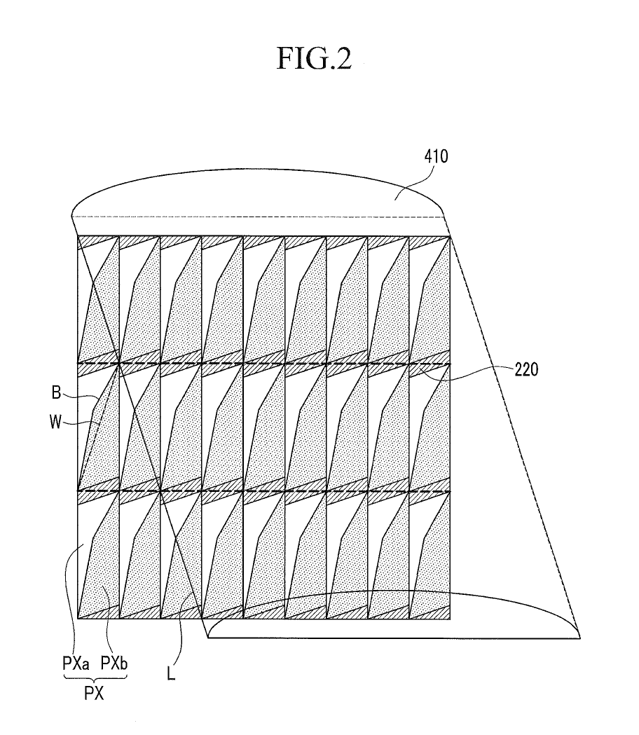

The width of the lenticular lens 410 may be substantially the same as the sum of the widths of a predetermined number of pixels. In other words, the width of the lenticular lens 410 may be substantially the same as a value obtained by multiplying the width of one pixel by the view number as established above. For example, referring to FIG. 2, the view number of the stereoscopic image display is 9, the width of the lenticular lens 410 is substantially the same as the sum of widths of nine pixels, the slope of the lens axis L is about −3, and the lens has nine facets. Alternative exemplary embodiments include configurations wherein the view number may be as high as 12, although alternative exemplary embodiments include configurations wherein the view number may be changed to be various values. In the exemplary embodiment wherein the view number is 9, the lenticular lens occupies nine pixels, and when the view number is 12, the lenticular lens occupies twelve pixels.

FIG. 2 is a top plan view schematically showing an exemplary embodiment of a stereoscopic image display according to the present invention.

One lenticular lens 410 occupies the pixels in about a 3×9 matrix, and other lenticular lenses are repeatedly disposed on the pixels in a similar way. Each pixel PX may show any one color of red, green and blue. For example, one pixel array may show one color, and a red pixel column, a green pixel column, and a blue pixel column may be sequentially and repeatedly disposed. Further, alternative exemplary embodiments include configurations wherein one lenticular lens 410 may occupy the pixels in a 3×12 matrix, in which each pixel may show any one color of red, green, blue, and white.

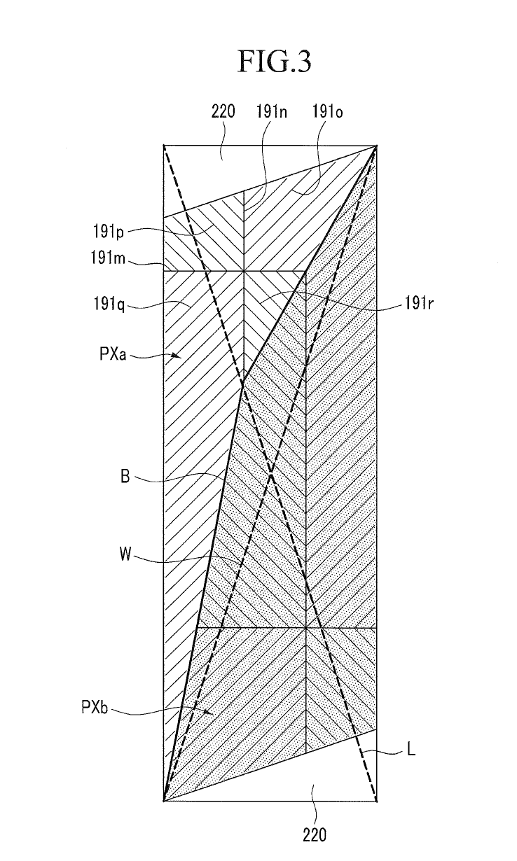

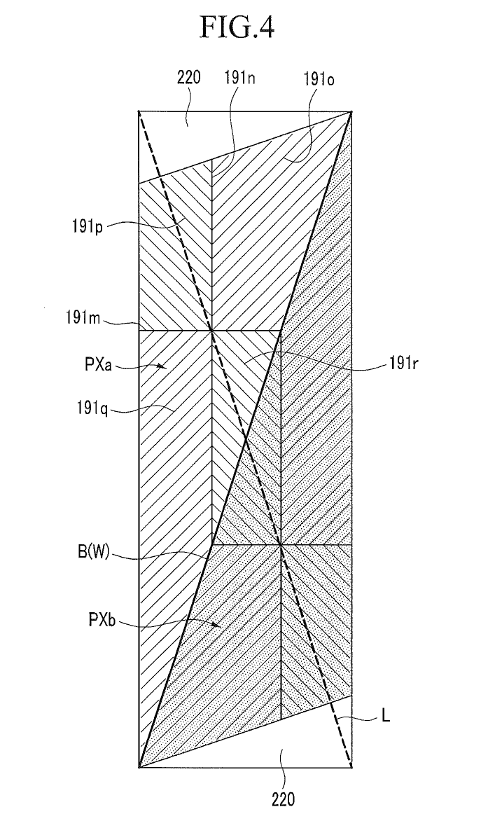

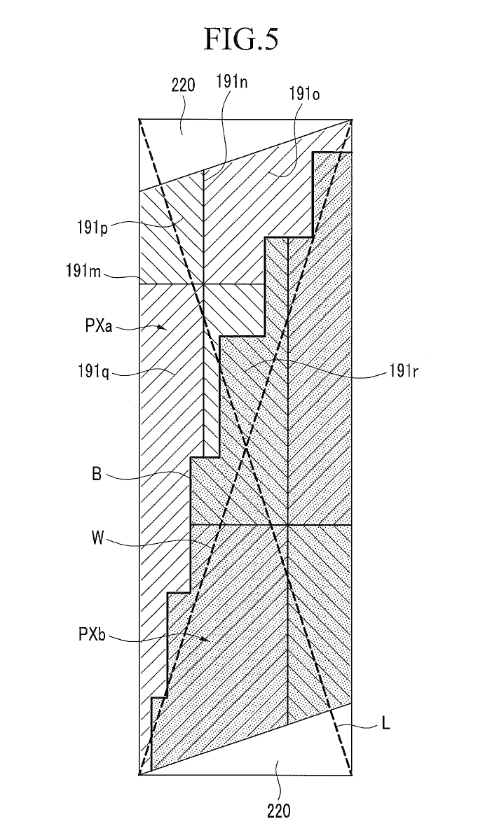

One pixel PX may include two subpixels PXa and PXb, and accordingly, side visibility, e.g., a viewing angle, of the display panel 300 may be improved. For example, the first subpixel PXa may be a high pixel showing high gray value image, and the second subpixel PXb may be a low pixel showing low gray value image. In the present exemplary embodiment, two subpixels PXa and PXb may be separated with reference to a line approximately connecting the upper right corner of the pixel PX with the lower left corner of the pixel PX. Alternative exemplary embodiments include configurations wherein the two subpixels PXa and PXb may be separated with reference to a line approximately connecting the upper left corner with the lower right corner of the pixel. Hereinafter, a line connecting two farthest corners of the pixel PX is referred to as a subpixel reference line W and the border line of the two subpixels PXa and PXb is referred to as a subpixel border line B; as shown in FIG. 2, the subpixel reference line W and the subpixel border line B are not the same. The subpixel border line B may be a curved line, an angled line (see FIG. 2 and FIG. 3), a straight line (see FIG. 4), or a stepped line (see FIG. 5), and exemplary embodiments include configurations wherein the subpixel border line B may be changed to have various shapes.

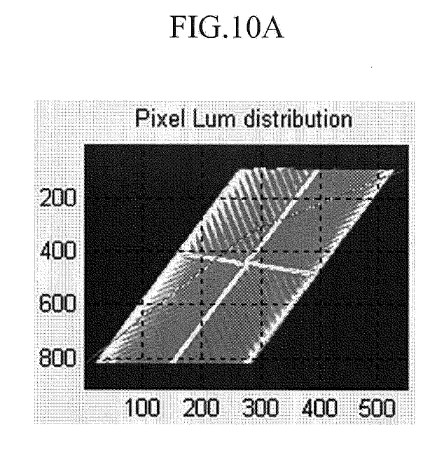

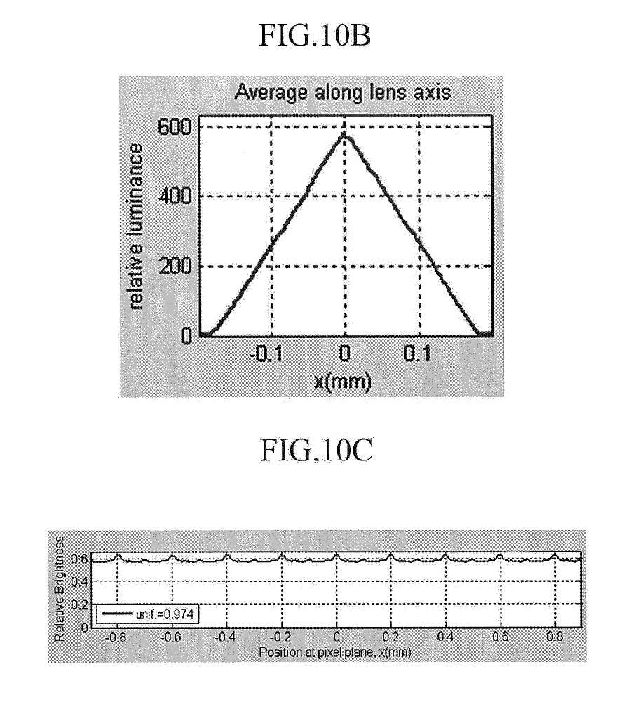

The lens axis L and the subpixel reference line W may be approximately left-right symmetric. In detail, a slope of the lens axis L may have substantially the same absolute value as a slope of the subpixel reference line W and the sign of the slope of the lens axis L may be opposite to the sign of the slope of the subpixel reference line W, e.g., the slopes may be opposite to one another. Accordingly, left and right luminance distributions with reference to the lens axis L in one pixel PX may be left-right symmetric, and the luminance may be uniform throughout a plurality of pixels. As a result, the display of a moire pattern may be reduced and the display quality of the stereoscopic image display may be improved. For example, referring to FIG. 2, the slope of the lens axis L is about −3, the slope of the subpixel reference line W is about +3, and the lens axis L and subpixel reference line W are approximately left-right symmetric. Furthermore, referring to FIG. 10A to FIG. 10C, left and right luminance distributions with reference to the lens axis in one pixel are left-right symmetric and luminance is uniform throughout all nine pixels of the lenticular lens. FIG. 10A to FIG. 10C are a luminance distribution image and luminance distribution graphs when a full white pattern is output from the stereoscopic image display of FIG. 2. The bright regions show a high gray value in the luminance distribution image of FIG. 10A. FIG. 10B is a graph showing luminance distribution of light passing through the lenticular lens in one pixel and FIG. 10C is a graph showing luminance distribution of light passing through the lenticular lens in nine pixels.

Alternatively, the left and right areas of the first subpixel PXa which are divided by the lens axis L may be substantially the same, and the left and right areas of the second subpixel PXb which are divided by the lens axis L may be substantially the same. Since luminance depends on an area of the pixel, luminance distribution may be left-right symmetric with reference to the lens axis L in one pixel PX and the luminance may be uniform throughout a plurality of pixels. As a result, the display of a moire pattern may be reduced and the display quality of the stereoscopic image display may be improved.

On the contrary, in an existing stereoscopic image display in which the areas of the left and right regions divided by a lens axis in a subpixel are substantially not the same, the luminance distribution is left-right asymmetric with reference to the lens axis in one pixel, such that a moire pattern may be undesirably shown.

In one exemplary embodiment, an approximate parallelogram shaped black matrix 220 may be disposed in the upper side portion and the lower side portion of a single pixel PX, as illustrated in FIG. 2. The black matrix 220 may be changed to have various shapes other than the parallelogram. The upper side and the lower side of the black matrix 220 may be approximately perpendicular to the axis L of the lenticular lens 410. Therefore, it is possible to prevent the black matrix 220 from being shown through the lenticular lens 410, and the display of a moire pattern may be reduced.

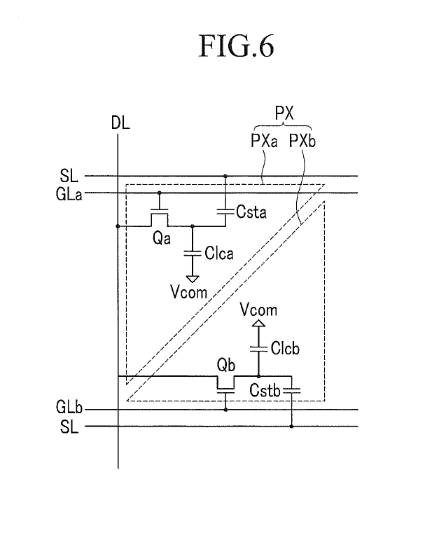

FIG. 3 a view enlarging one pixel PX of the exemplary embodiment of a stereoscopic image display of FIG. 2 and FIG. 6 is an equivalent circuit diagram of one pixel PX of the exemplary embodiment of a stereoscopic image display of FIG. 2.

The first subpixel PXa and the second subpixel PXb each may include branch pixel electrodes 191m, 191n, 191o, 191p, 191q, and 191r, although the branch pixel electrodes are only labeled in the first subpixel PXa for clarity in FIG. 3. The first subpixel PXa includes an approximately horizontal branch electrode 191m and an approximate vertical branch electrode 191n. Further, the first subpixel PXa includes an upper-right branch electrode 191o extending in the upper-right direction from the horizontal branch electrode 191n, a lower-left branch electrode 191p extending in the upper-left direction, a lower-left branch electrode 191q extending in the lower-left direction, and a lower-right branch electrode 191r extending in the lower-right direction. Accordingly, in the present exemplary embodiment the first subpixel PXa has four domains; an upper-right domain, an upper-left domain, a lower-left domain, and a lower-right domain, with reference to the horizontal branch electrode 191m and the horizontal branch electrode 191n, and the directions of the liquid crystals are different in the four domains, and thus, the viewing angle of the display panel 300 may be widened. A plurality of the upper-right branch electrodes 191o may be disposed in the upper-right domain and the plurality of upper-right branch electrodes 191o may be approximately parallel with each other, and connection branch electrodes (not shown) connecting the ends of the plurality of upper-right branch electrodes 191o may be additionally included in some exemplary embodiments. Similarly, a plurality of upper-left branch electrodes 191p may be approximately parallel with each other, connection branch electrodes (not shown) connecting the ends of the plurality of upper-right branch electrodes 191p may be additionally included in some exemplary embodiments. Further, a plurality of lower-left branch electrodes 191q may be approximately parallel with each other and connection branch electrode (not shown) connecting the ends of the plurality of lower-left branch electrodes 191q may be additionally included in some exemplary embodiments. Furthermore, a plurality of lower-right electrodes 191r may be approximately parallel with each other and connection branch electrodes (not shown) connecting the ends of the plurality of lower-right electrodes 191r may be additionally included in some exemplary embodiments.

Exemplary embodiments of the second subpixel PXb may include, similar to the first subpixel PXa, a horizontal branch electrode, a vertical branch electrode, an upper-right branch electrode, an upper-left branch electrode, a lower-left branch electrode, and a lower-right branch electrode, and accordingly four domains, an upper-right domain, an upper-left domain, a lower-left domain, and a lower-right domain may be disposed, and thus, the viewing angle of the display panel 300 may be widened. Further, a connection branch electrode (not shown) may be additionally included in some exemplary embodiments. While the first and second subpixels PXa and PXb have been described as having four domains, alternative exemplary embodiments include configurations having one or more domains.

Referring to FIG. 3 and FIG. 6, an approximate triangular black matrix 220 may be disposed at the upper end portion and the lower end portion of the pixel PX, and at least one of TFTs Qa and Qb, storage electrodes Csta and Cstb, and a contact hole (not shown) may be disposed at a region overlapping the black matrix 220.

Referring to FIG. 3, since the areas of the region at the left side from the lens axis L and the region at the right side from the lens axis L in the first subpixel PXa may be substantially the same, or the subpixel reference line W is approximately left-right symmetric to the lens axis L, left and right luminance distributions with reference to the lens axis L may be left-right symmetric, luminance may be uniform throughout a plurality of pixels, and a display of a moire pattern may be reduced.

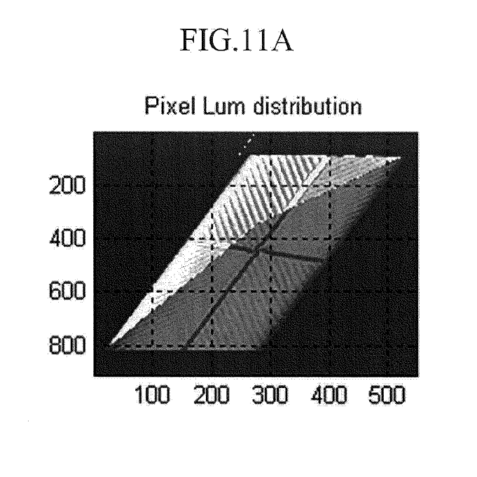

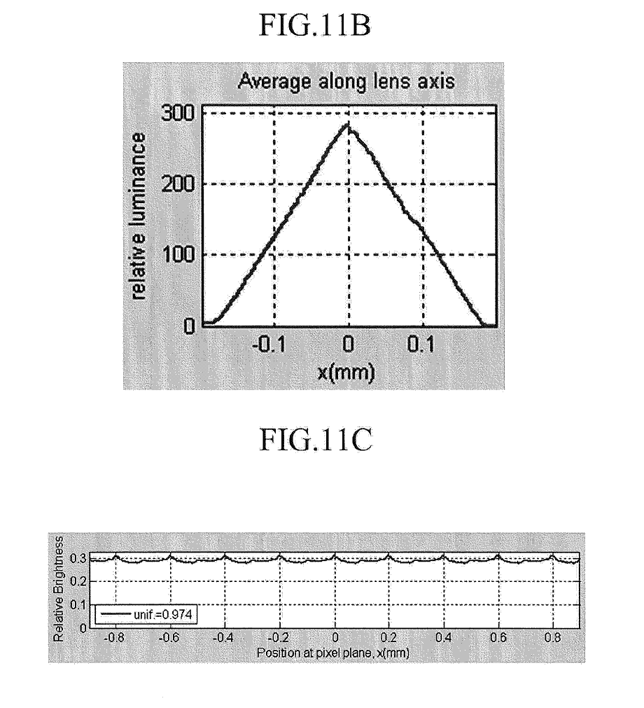

Further, referring to FIG. 11A to FIG. 11C, left and right luminance distributions with reference to the lens axis in one pixel are left-right symmetric, and luminance is uniform throughout nine pixels. FIG. 11A to FIG. 11C are a luminance distribution image and luminance distribution graphs when a low-gray pattern is output from the stereoscopic image display of FIG. 3. The bright region shows high gray values in the luminance distribution image of FIG. 11A. FIG. 11B is a graph showing luminance distribution of light passing through a lenticular lens in one pixel and FIG. 11C is a graph showing luminance distribution of light passing through a lenticular lens in nine pixels.

In the second subpixel PXb, similar to the first subpixel PXa, the areas of the region at the left side from the lens axis L and the region at the right side from the lens axis L may be substantially the same, or the subpixel reference line W may be approximately left-right symmetric to the lens axis L.

The subpixel border line B is an angled line, also referred to herein as a “curved line”, and the angled point is disposed above the subpixel reference line W, e.g., it appears on an opposite side of the subpixel reference line W from a majority of the subpixel. Further, the angled point may be disposed on the lens axis L. The subpixel border line B may divide the area of the first subpixel PXa and the area of the second subpixel PXb in a ratio of about 1:2, and accordingly, the side visibility of the display panel 300 may be improved.

FIG. 4 is a view enlarging a pixel PX of another exemplary embodiment of a stereoscopic image display according to the present invention.

Referring to FIG. 4, the subpixel border line B and the subpixel reference line W may approximately agree, e.g., overlap along the lengths thereof, and the subpixel reference line W may be a straight line. In the subpixels PXa and PXb, since the areas of the region at the left side from the lens axis L and the region at the right side from the lens axis L may be substantially the same, or the subpixel reference line W is approximately left-right symmetric to the lens axis L, left and right luminance distributions with reference to the lens axis L may be left-right symmetric, luminance may be uniform throughout a plurality of pixels, and the display of a moire pattern may be reduced.

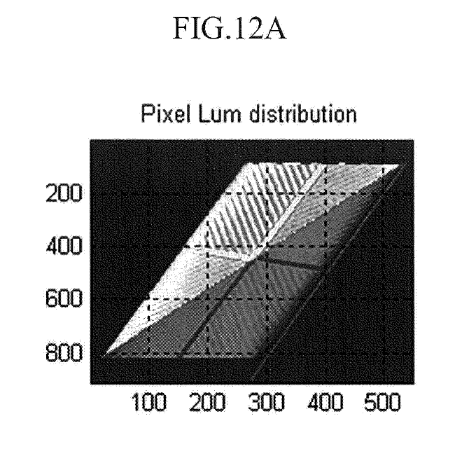

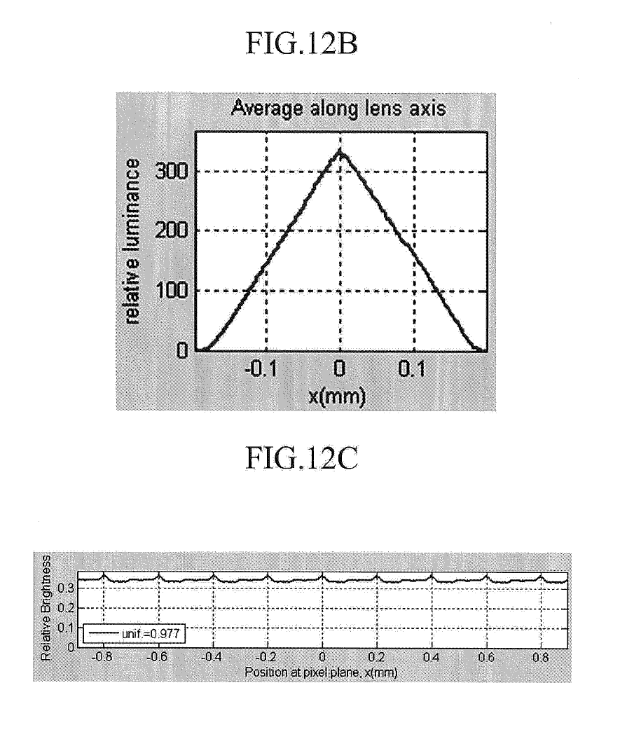

Furthermore, referring to FIG. 12A to FIG. 12C, left and right luminance distributions with reference to the lens axis in one pixel are left-right symmetric, and luminance is uniform throughout nine pixels. FIG. 12A to FIG. 12C are a luminance distribution image and luminance distribution graphs when a low-gray scale pattern is output from the stereoscopic image display of FIG. 4. The bright region shows high gray scale in the luminance distribution image of 12A. FIG. 12B is a graph showing luminance distribution of light passing through a lenticular lens in one pixel and FIG. 12C is a graph showing luminance distribution of light passing through a lenticular lens in nine pixels.

The subpixel border line B may divide the area of the first subpixel PXa and the area of the second subpixel PXb in a ratio of about 1:1, and accordingly, the side visibility of the display panel 300 may be improved.

Alternative exemplary embodiments include configurations wherein the area ratio of the first subpixel PXa and the second subpixel PXb may be about 1:0.5 to about 1:3. In such exemplary embodiments, the subpixel border line B may be a curved line having an angled point, and the angled point may be disposed on the lens axis L. As the area of the second subpixel PXb becomes larger than the area of the first subpixel PXa, the side visibility of the display panel 300 may be improved, while as the area of the first subpixel PXa becomes larger than the area of the second subpixel PXb, the luminance of the display panel 300 may be improved. Therefore, when the area of the first subpixel PXa is greater than about two times of the area of the second subpixel PXb though the luminance may be improved, the side visibility may be undesirably deteriorated. When the area of the first subpixel PXa is smaller than about three times of the area of the second subpixel PXb, though the side visibility may be improved, the luminance may be undesirably deteriorated.

The subpixels PXa and PXb each may have a horizontal branch electrode, vertical branch electrode, an upper-right branch electrode, an upper-left branch electrode, a lower-left branch electrode, and a lower-right electrode, and accordingly, four domains, an upper-right domain, an upper-left domain, a lower-left domain, and a lower-right domain, may be disposed, and thus, the viewing angle of the display panel 300 may be widened. Further, a connection branch electrode (not shown) may be additionally included in some exemplary embodiments.

FIG. 5 is an enlarged view of a pixel PX of another exemplary embodiment of a stereoscopic image display according to the present invention.

Referring to FIG. 5, the subpixel border line B may be stepped shape. In the subpixels PXa and PXb, since the areas of the region at the left side from the lens axis L and the region at the right side from the lens axis L may be substantially the same, or the subpixel reference line W is approximately left-right symmetric to the lens axis L, left and right luminance distributions with reference to the lens axis L may be left-right symmetric, luminance may be uniform throughout a plurality of pixels, and the display of a moire pattern may be decreased.

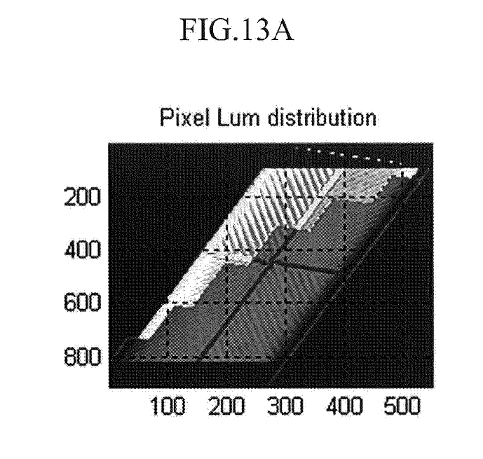

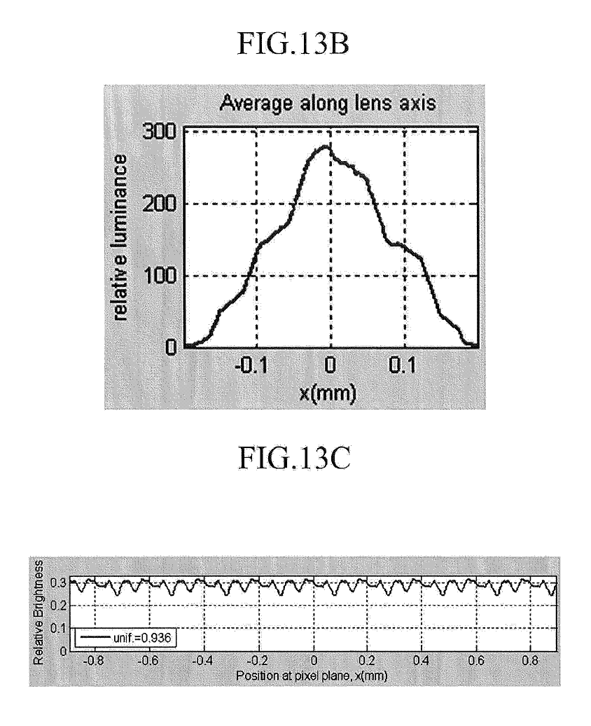

Further, referring to FIG. 13A to FIG. 13C, left and right luminance distributions with reference to the lens axis in one pixel are left-right symmetric, and luminance is uniform throughout nine pixels. FIG. 13A to FIG. 13C are a luminance distribution image and luminance distribution graphs when a low-gray scale pattern is output from the stereoscopic image display of FIG. 5. The bright region shows high gray scale in the luminance distribution image of 13A. FIG. 13B is a graph showing luminance distribution of light passing through a lenticular lens in one pixel and FIG. 13C is a graph showing luminance distribution of light passing through a lenticular lens in nine pixels.

The subpixel border line B may divide the area of the first subpixel PXa and the area of the second subpixel PXb in a ratio of about 1:1, and accordingly, the side visibility of the display panel 300 may be improved.

The subpixels PXa and PXb each may have a horizontal branch electrode, vertical branch electrode, an upper-right branch electrode, an upper-left branch electrode, a lower-left branch electrode, and a lower-right electrode, and accordingly, four domains, an upper-right domain, an upper-left domain, a lower-left domain, and a lower-right domain, may be disposed, and thus, the viewing angle of the display panel 300 may be widened. Further, a connection branch electrode (not shown) may be additionally included in some exemplary embodiments.

The equivalent circuit diagram of the pixel PX shown in FIG. 6 may be applied to the exemplary embodiment of a stereoscopic image display of FIG. 1 to FIG. 5.

Referring to FIG. 6, a pair of gate lines GLa and GLb extends in approximately the row direction, a data line DL extends in approximately the column direction, and a plurality of storage electrode lines SL extends in approximately the row direction.

The pixel PX includes a pair of subpixels PXa and PXb, the subpixels PXa and PXb each include at least one of switching element Qa and Qb, liquid crystal capacitors Clca and Clcb, and storage capacitors Csta and Cstb, although alternative exemplary embodiments include configurations wherein the storage capacitors Csta and Cstb may be omitted.

The switching elements Qa and Qb are TFTs provided in the display panel 300, of which the control terminal is connected with the gate lines GLa and GLb, the input terminal is connected with the data line DL, and the output terminal is connected with the liquid crystal capacitors Clca and Clcb and the storage capacitor Csta and Cstb.

The liquid crystal capacitors Clca and Clcb have two opposing terminals as the pixel electrodes 191m, 191n, 191o, 191p, 191q, and 191r and the common electrode (not shown), and the liquid crystal layer (not shown) between the two terminals, is included as a dielectric material. A common voltage Vcom may be applied to a common electrode (not shown).

In the storage capacitors Csta and Cstb that complement the liquid crystal capacitors Clca and Clcb, the storage electrode line SL and the pixel electrodes 191m, 191n, 191o, 191p, 191q, and 191r overlap each other, and an insulator disposed between the storage electrode line SL and the pixel electrodes 191m, 191n, 191o, 191p, 191q, and 191r. A predetermined voltage, such as a common voltage Vcom, is applied to the storage electrode line SL.

FIG. 7 is a top plan view schematically showing another exemplary embodiment of a stereoscopic image display according to the present invention.

One lenticular lens 410 occupies the pixels PX in about a 3×9 matrix and lenticular lenses are repeatedly disposed in a similar way throughout the display.

Each pixel PX may show any one color of red, green and blue. For example, in one exemplary embodiment one pixel array may show one color, and a red pixel column, a green pixel column, and a blue pixel column may be sequentially and repeatedly disposed. Alternative exemplary embodiments include configurations wherein one lenticular lens 410 may occupy the pixels in a 3×12 matrix, in which each pixel may show any one color of red, green and blue, and white.

One pixel PX may include two subpixels PXa and PXb, and accordingly, the side visibility of the display panel 300 may be improved. For example, in one exemplary embodiment the first subpixel PXa may be a high pixel showing high gray scale images and the second subpixel PXb may be a low pixel showing low gray scale images.

The subpixel border line B may be approximately parallel with the lens axis L, left and right luminance distributions with reference to the lens axis L in one pixel PX may be left-right symmetric, and luminance may be uniform throughout a plurality of pixels. As a result, the display of a moire pattern may be reduced and the display quality of the stereoscopic image display may be improved.

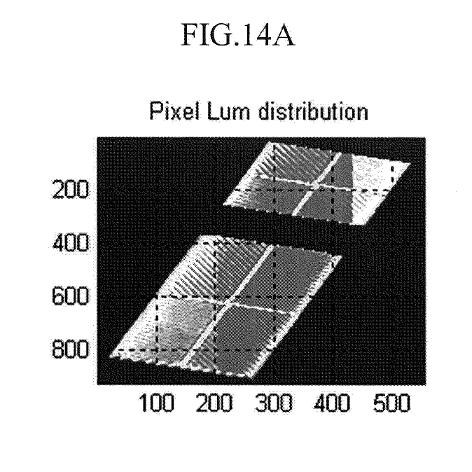

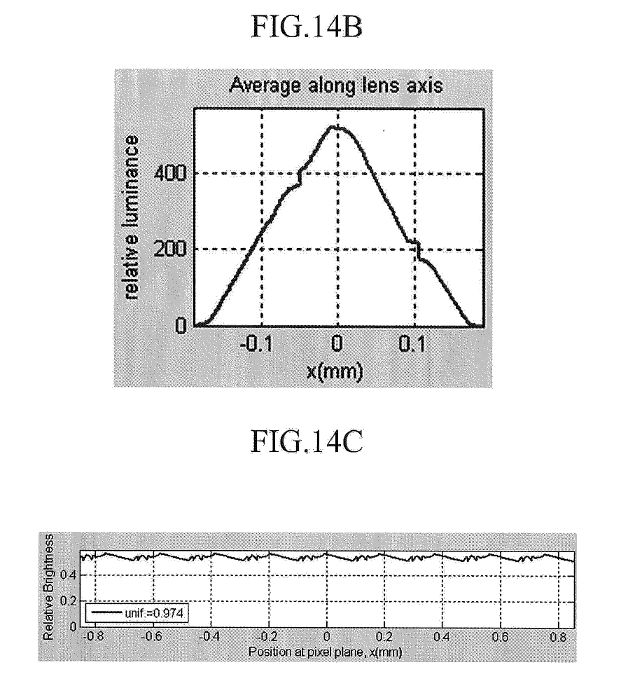

Further, referring to FIG. 14A to FIG. 14C, it may be seen that luminance distribution is left-right symmetric with reference to the lens axis in one pixel, and the luminance is uniform throughout nine pixels. FIG. 14A to FIG. 14C are a luminance distribution image and luminance distribution graphs when a low-gray pattern is output from the exemplary embodiment of a stereoscopic image display of FIG. 7. The bright region shows high gray scale in the luminance distribution image of 14A. FIG. 14B is a graph showing luminance distribution of light passing through a lenticular lens in one pixel and FIG. 14C is a graph showing luminance distribution of light passing through a lenticular lens in nine pixels.

The first subpixel PXa is an hourglass shape having a shape of two right triangles, which are disposed at the lower-left corner and the upper-right corner, respectively, in the pixel PX. In this exemplary embodiment, the height ratio of the right triangle at the lower-left corner and the right triangle at the upper-right corner may be about 2:1. That is, the length ratio of the upper part and the lower part of the hourglass may be about 2:1.

A black matrix 220 extending approximately in the row direction may be disposed on the upper side portion and the lower side portion of one pixel PX. The black matrix 220 may be changed to have various other shapes.

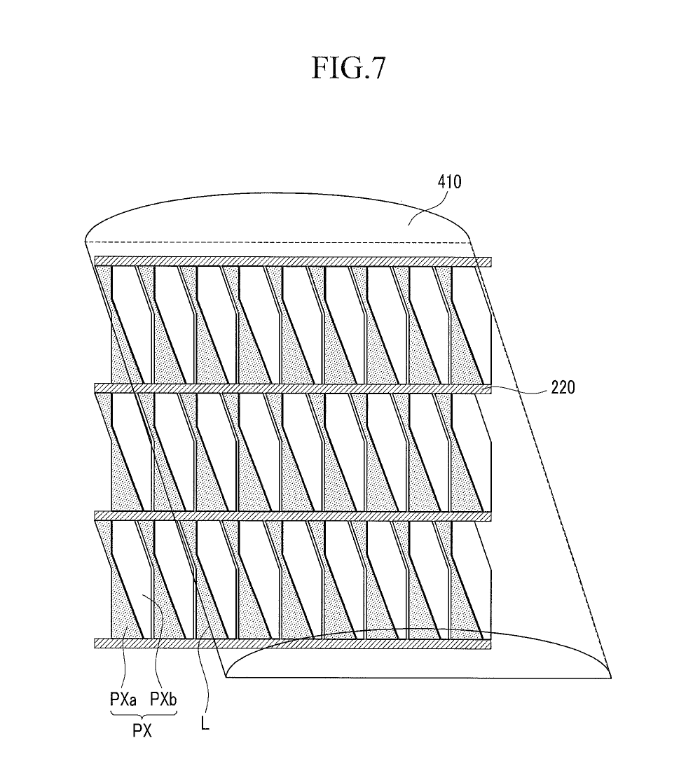

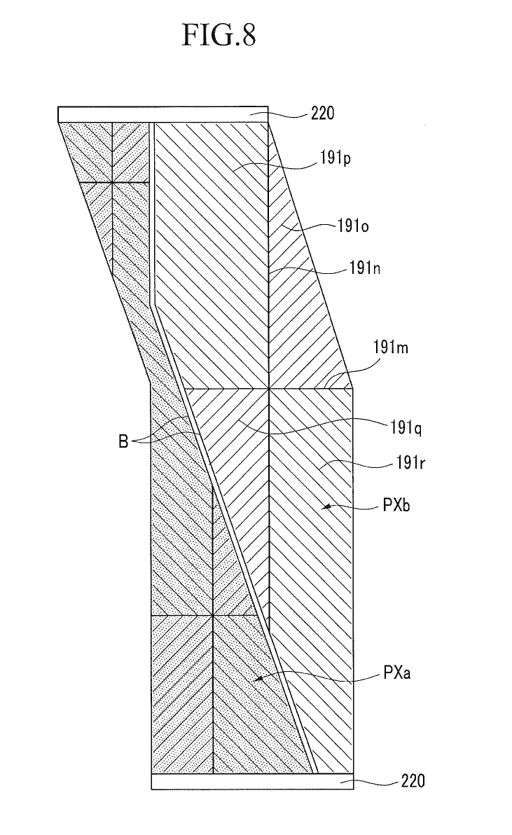

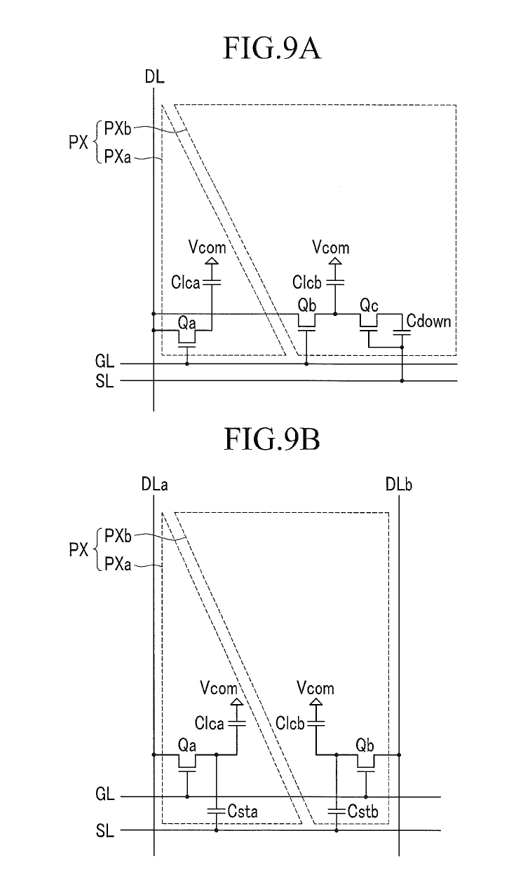

FIG. 8 is an enlarged view of one pixel PX of the exemplary embodiment of a stereoscopic image display of FIG. 7 and FIG. 9A is an equivalent circuit diagram of one pixel PX of the exemplary embodiment of a stereoscopic image display of FIG. 7.

The subpixels PXa and PXb each may have a horizontal branch electrode, vertical branch electrode, an upper-right branch electrode, an upper-left branch electrode, a lower-left branch electrode, and a lower-right electrode, and accordingly, four domains, an upper-right domain, an upper-left domain, a lower-left domain, and a lower-right domain, may be included in some exemplary embodiments. A pair of horizontal branch electrode and vertical branch electrode may be disposed in the right triangle at the upper-left corner of the first subpixel PXa, and a pair of horizontal branch electrode and vertical branch electrode may be disposed in the right triangle at the lower-left corner. Further, the first subpixels PXa each may include a horizontal branch electrode, a vertical branch electrode, an upper-right branch electrode, an upper-left branch electrode, a lower-left branch electrode, and a lower-right electrode. Accordingly, the viewing angle of the display panel 300 may be widened. Furthermore, in some exemplary embodiments the subpixels PXa and PXb may additionally include a connection branch electrode (not shown).

Referring to FIG. 8 and FIG. 9A, a black matrix 220 extending in approximately the row direction may be disposed at the upper end portion and the lower end portion of the pixel PX, and TFTs Qa, Qb, and Qc, storage electrodes Csta and Cstb, and a contact hole (not shown) may be disposed at a region overlapping the black matrix 220.

Referring to FIG. 9A, a gate line GL extends in approximately the row direction, a data line DL extends approximately in the column direction, and a plurality of storage electrode lines SL extends in approximately the row direction.

The pixel PX includes a pair of subpixels PXa and PXb and the subpixels PXa and PXb include at least one of switching elements Qa, Qb, and Qc, liquid crystal capacitors Clca and Clcb, and a down capacitor Cdown.

The first switching element Qa and the second switching element Qb are TFTs provided in the display panel 300, of which the control terminal is connected with the gate line GL, the input terminal is connected with the data line DL, and the output terminal is connected with the liquid crystal capacitors Clca and Clcb.

The control terminal and the output terminal of the third switching element Qc are connected to both ends of the down capacitor Cdown, respectively, and the input terminal is connected to the liquid crystal capacitor Clcb.

The liquid crystal capacitors Clca and Clcb have two opposing terminals as the pixel electrodes 191m, 191n, 191o, 191p, 191q, and 191r and the common electrode (not shown), and the liquid crystal layer (not shown), as a dielectric material, is disposed between the two terminals. A common voltage Vcom may be applied to a common electrode (not shown).

When a data voltage having positive polarity is applied to the data line DL, the voltage is distributed in accordance with the capacity of the liquid crystal capacitor Clcb and the down capacitor Cdown. Accordingly, the voltage of the output terminal of the second switching element Qb equals the voltage of the output terminal of the third switching element Qc and the voltage of the output terminal of the first switching element Qa is maintained at the level of the data voltage. Therefore, the magnitude of the voltage applied to the second subpixel PXb becomes smaller than that of the voltage applied to the first subpixel PXa. Consequently, when voltage having positive polarity is applied, the first subpixel PXa becomes a high region and the second subpixel PXb becomes a low region.

FIG. 9B is an equivalent circuit diagram of one pixel PX according to another exemplary embodiment of the stereoscopic image display of FIG. 7. The description about FIGS. 7 and 8 may be applied to the description about FIG. 9B.

Referring to FIG. 9B, one pixel PX includes a pair of subpixels PXa and PXb. The first subpixel PXa includes a first switching element Qa connected with a gate line GL and a first data line DLa and a first liquid crystal capacitor Clca connected to the first switching element Qa. Furthermore, the first subpixel PXa may selectively further include a first storage capacitor Csta connected to a storage electrode line SL. The second subpixel PXb includes a second switching element Qb connected to the gate line GL and a second data line DLb and a second liquid crystal capacitor Clcb connected to the second switching element Qb. Furthermore, exemplary embodiments include configurations wherein the second subpixel PXb may selectively further include a second storage capacitor Cstb connected to a storage electrode line SL.

According to the exemplary embodiments of the present invention, it is possible to reduce a moire pattern, improve side visibility of the display panel and display quality of the stereoscopic image display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A stereoscopic image display comprising:
a display panel comprising a pixel comprising:
a first subpixel; and
a second subpixel disposed adjacent to the first subpixel,
wherein the first subpixel and the second subpixel are adjacent along a subpixel border line which is a virtual line disposed at an interface between the first subpixel and the second subpixel; and
a lenticular lens disposed on the display panel, the lenticular lens having a lens axis,
wherein the lens axis is a line where a curved surface of the lenticular lens and a bottom surface of the lenticular lens meet, and the lens axis and the subpixel border line intersect each other.

2. The stereoscopic image display of claim 1, wherein a left region of the first subpixel and a right region of the first subpixel are divided by the lens axis, and an area of the left region of the first subpixel is substantially the same as an area of the right region of the first subpixel.

3. The stereoscopic image display of claim 2, wherein a left region of the second subpixel and a right region of the second subpixel are divided by the lens axis, and an area of the left region of the second subpixel is substantially the same as an area of the right region of the second subpixel.

4. The stereoscopic image display of claim 3, wherein two corners of the pixel face each other, and the lens axis connects the two corners of the pixel.

5. The stereoscopic image display of claim 4, wherein an absolute value of a slope of the lens axis is about 3 to about 6 as measured from a top plan view perspective.

6. The stereoscopic image display of claim 3, wherein an area ratio of the first subpixel and the second subpixel is about 1:0.5 to about 1:3.

7. The stereoscopic image display of claim 1, wherein the subpixel border line is a curved line.

8. The stereoscopic image display of claim 1, wherein the subpixel border line is a straight line.

9. The stereoscopic image display of claim 1, wherein the subpixel border line has a stepped shape.

10. The stereoscopic image display of claim 1, wherein the display panel further comprises a first black matrix disposed at an upper end portion of the pixel and a second black matrix disposed at a lower end portion of the pixel.

11. The stereoscopic image display of claim 10,
wherein the first subpixel comprises a first switching element, and the first switching element overlaps the first black matrix, and
wherein the second subpixel comprises a second switching element, and the second switching element overlaps the second black matrix.

12. The stereoscopic image display of claim 11,
wherein the first subpixel further comprises a first storage capacitor, and the first storage capacitor overlap the first black matrix, and
wherein the second subpixel further comprises a second storage capacitor, and the second storage capacitor overlaps the second black matrix.

13. The stereoscopic image display of claim 11, wherein the display panel further comprises a first gate line, a second gate line and a data line, the first switching element is connected to the first gate line and the data line, and the second switching element is connected to the second gate line and the data line.

14. The stereoscopic image display of claim 1,
wherein the first subpixel further comprises a first horizontal branch electrode and a first vertical branch electrode, and
wherein the second subpixel comprises a second horizontal branch electrode and a second vertical branch electrode.

15. The stereoscopic image display of claim 14,
wherein the first subpixel further comprises a first upper-right branch electrode, a first upper-left branch electrode, a first lower-left branch electrode, and a first lower-right electrode, and
wherein the second subpixel further comprises a second upper-right branch electrode, a second upper-left branch electrode, a second lower-left branch electrode, and a second lower-right electrode.

16. The stereoscopic image display of claim 1, wherein a width of the lenticular lens is substantially the same as a product of a width of the pixel and a view number, and the view number is a number of pixels covered by the lenticular lens.

17. The stereoscopic image display of claim 16, wherein the curved surface of the lenticular lens comprises both a cylindrical surface and a faceted surface.

18. The stereoscopic image display of claim 17, wherein a number of facets is the same as the view number of the stereoscopic image display.

19. A stereoscopic image display, comprising:
a display panel comprising a pixel comprising:
a first subpixel; and
a second subpixel disposed adjacent to the first subpixel,
wherein the first subpixel and the second subpixel are adjacent along a subpixel border line which is a virtual line disposed at an interface between the first subpixel and the second subpixel; and
a lenticular lens disposed on the display panel, the lenticular lens having a lens axis,
wherein the lens axis is a line where a curved surface of the lenticular lens and a bottom surface of the lenticular lens meet, and a portion of the subpixel border line is substantially parallel with the lens axis.

20. The stereoscopic image display of claim 19, wherein the second subpixel has an hourglass shape.

21. The stereoscopic image display of claim 20, wherein a length ratio of an upper part and a lower part of the hourglass is about 2:1.

22. The stereoscopic image display of claim 19, wherein the display panel further comprises a black matrix disposed on one of an upper end portion of the pixel and a lower end portion of the pixel.

23. The stereoscopic image display of claim 22,
wherein the first subpixel comprises a first switching element, and
wherein the second subpixel comprises a second switching element, and
wherein the black matrix overlaps the first switching element and the second switching element.

24. The stereoscopic image display of claim 23, wherein the display panel further comprises a gate line and a data line, the first switching element is connected to the gate line and the data line, and the second switching element is connected to the gate line and the data line.

25. The stereoscopic image display of claim 24, wherein the first subpixel further comprises a third switching element connected to the first switching element and a down capacitor connected to the third switching element, and opposing terminals of the down capacitor are connected to a control electrode of the third switching element and an output electrode of the third switching element, respectively.

26. The stereoscopic image display of claim 23, wherein the display panel further comprises a gate line, a first data line, and a second data line, the first switching element is connected to the gate line and the first data line, and the second switching element is connected to the gate line and the second data line.

27. The stereoscopic image display of claim 19, wherein:
the first subpixel comprises a first horizontal branch electrode and a first vertical branch electrode, and the second subpixel comprises a second horizontal branch electrode and a second vertical branch electrode.

28. The stereoscopic image display of claim 27,
wherein the first subpixel comprises a first upper-right branch electrode, a first upper-left branch electrode, a first lower-left branch electrode, and a first lower-right electrode, and
wherein the second subpixel comprises a second upper-right branch electrode, a second upper-left branch electrode, a second lower-left branch electrode, and a second lower-right electrode.
